(19) United States
(12) Patent Application Publication
(10) Pub. No.: US 2019/0301407 A1
(43) Pub. Date: Oct. 3, 2019

(54) PLASMA GENERATION DEVICE FOR INTERNAL COMBUSTION ENGINE

(71) Applicant: Fang Chui Tech USA, Inc., Flushing, NY (US)

(72) Inventors: Baozhen YANG, Beijing (CN); Zhengxing YANG, Worcester, MA (US)

(21) Appl. No.: 16/368,959

(22) Filed: Mar. 29, 2019

Related U.S. Application Data
(60) Provisional application No. 62/651,015, filed on Mar. 30, 2018.

(51) Int. Cl. F02M 27/04; H05H 1/48

(52) U.S. Cl. CPC F02M 27/042; H05H 2001/485; H05H 1/48

(57) ABSTRACT

This invention relates to a device for increasing fuel efficiency and reducing post-combustion pollutant gas emission for internal combustion engines. In one embodiment, the present invention discloses a device with an inner circular electrode with gear-shaped outer circumference and an outer cylindrical electrode. The generated plasma between electrodes breaks the air molecules, and forms ozone and charged moieties, significantly improving the combustion efficiency and post-combustion pollutant gas emission. In one embodiment, the device further comprises one or more brushes. In one embodiment, the invention also discloses a system comprising: 1) the device described herein, 2) a voltage controlling system, and 3) a humidity controlling system. In one embodiment, the fuel consumption can be reduced by 2% to 55%. In one embodiment, the pollutant gas emission can be reduced by 25% to 99%.

### CROSS-REFERENCE TO RELATED APPLICATIONS

This application claims the benefit of U.S. Provisional Application No. 62/651,015, filed Mar. 30, 2018. The entire contents and disclosures of the preceding application are incorporated by reference into this application. Throughout this application, various publications are cited. The disclosures of these publications in their entireties are hereby incorporated by reference into this application to more fully describe the state of the art to which this invention pertains.

### FIELD OF THE INVENTION

In one embodiment, this application is related to a generation device. In one embodiment, this application is related to a plasma generation device for an internal combustion engine. In one embodiment, it improves the performance of the internal combustion engine, decreases fuel consumption and reduces post-combustion emissions.

### BACKGROUND OF THE INVENTION

It has been proved that ozone can positively influence combustion as a strong oxidant. According to Yiguang Ju, et al. Progress in Energy and Combustion Science, 2015, 48, 21-83., plasma can break the bonds of the molecules of the air due to its high energy. During this process, ozone and ionic wind are formed. With the help of ozone flowing into the combustion chambers, fuel consumption of the internal combustion engine can be lowered and post-combustion emission can be significantly decreased. Conventionally, planar electrodes are used for plasma generation and it usually requires high power input, and/or a high temperature.

### SUMMARY OF THE INVENTION

In one aspect, the present invention provides an electrode with a curved shape for plasma generation so as to fit the air intake tube of an internal combustion engine. In one embodiment, the electrode is configured in a circular or cylindrical shape. In one embodiment, the shape of the electrode is configured as any other shapes that fit the air intake tube of the internal combustion engine.

In another aspect, the present invention also discloses an electrode pair, in which the circumference of one electrode is smooth and the circumference of the other electrode is gear-shaped. In one embodiment, the electrode with smooth circumference is a hollow cylindrical electrode. In one embodiment, the electrode with gear-shaped circumference is a flat electrode. In one embodiment, such electrode pair (or assembly) comprise one electrode with smooth circumference and multiple gear shaped electrodes. In another aspect, the plasma generation is conducted in a mild condition. In one embodiment, the plasma is conducted with a low power input at a low temperature manner. In one embodiment, the power input is in a range of 1-100 W. In one embodiment, the temperature is in a range of −100° C. to 100° C. In one embodiment, the present invention provides a vapor-generation or water injection device in connection with the plasma generation device.

In another embodiment, the present invention also discloses an electrode assembly or configuration, in which each of the cylindrical or circular electrode is gear-shaped. In one embodiment, the gears on each electrode share the same shape. In one embodiment, the gears on electrodes are different. In one embodiment, electrodes are assembled in a manner that can facilitate the generation of plasma, ozone, and/or charged moieties, which can enhance the performance of internal combustion engine.

Configurations disclosed herein provide a plasma generation device for internal combustion engine. In one embodiment, the device can be adapted to be placed in the air intake of an internal combustion engine. In one embodiment, the device significantly increases the efficiency and performance of the internal combustion engine. In one embodiment, the plasma occurs in between two electrodes with a voltage (or voltage difference) sufficient to trigger a plasma. In one embodiment, the voltage (or voltage difference) is around 20,000 V. In one embodiment, the voltage is in a range of 500 to 1,000 V. In one embodiment, the voltage is in a range of 1,000 to 10,000 V. In one embodiment, the voltage is in a range of 10,000 to 20,000 V. In one embodiment, the voltage varies on the dielectric barrier material between the electrodes.

In one embodiment, plasma generation takes place adjacent to a combustion cylinder. By blowing the ozone and charged moieties into the combustion cylinder, the kinetic energy for cylinder displacement can be enhanced because the charged moieties and ozone probably increase combustion efficiency as a strong oxidant. In one embodiment, the fuel for the internal combustion engine includes but is not limited to gasoline and diesel.

### BRIEF DESCRIPTION OF THE FIGURES

FIG. 1 shows a configuration of the device according to one embodiment of the present invention (1: beam (alternatively, “spindle”); 2: brush supporter; 3: brush; 4: separating unit; 5: spacer; 6: gear-shaped circular electrode; 7: fastener; 8: cylindrical electrode; 9: dielectric barrier layer; 10: supporting foot; 11: fixing spring.)

FIG. 2 shows another configuration of the device according to one embodiment of the present invention. (1: spindle; 2: brush supporter; 3: brush; 4: separating unit; 5: spacer; 6: gear-shaped electrode; 7: fastener; 8: cylindrical electrode with a fixing spring; 9: dielectric barrier layer)

FIG. 3 shows a typical assembly of the device according to one embodiment of the present invention.

FIG. 4 shows another typical assembly of the device according to one embodiment of the present invention.

FIG. 5 shows a left view of FIG. 4 according to one embodiment of the present invention.

FIG. 6 shows a typical assembly of the device with a non-conductive separating unit (4) that electrically separate the circular electrodes and cylindrical electrode according to one embodiment of the present invention.

FIG. 7 shows a curve of fuel consumption in Example 1 according to one embodiment of the invention.

FIG. 8 shows a curve of fuel consumption in Example 2 according to one embodiment of the invention.

FIG. 9 shows an acceleration curve of the vehicle with and without the device (speed vs time) according to one embodiment of the invention.

FIG. 10 shows an acceleration curve of the vehicle with and without the device (speed vs distance) according to one embodiment of the invention.

### DETAILED DESCRIPTION OF THE INVENTION

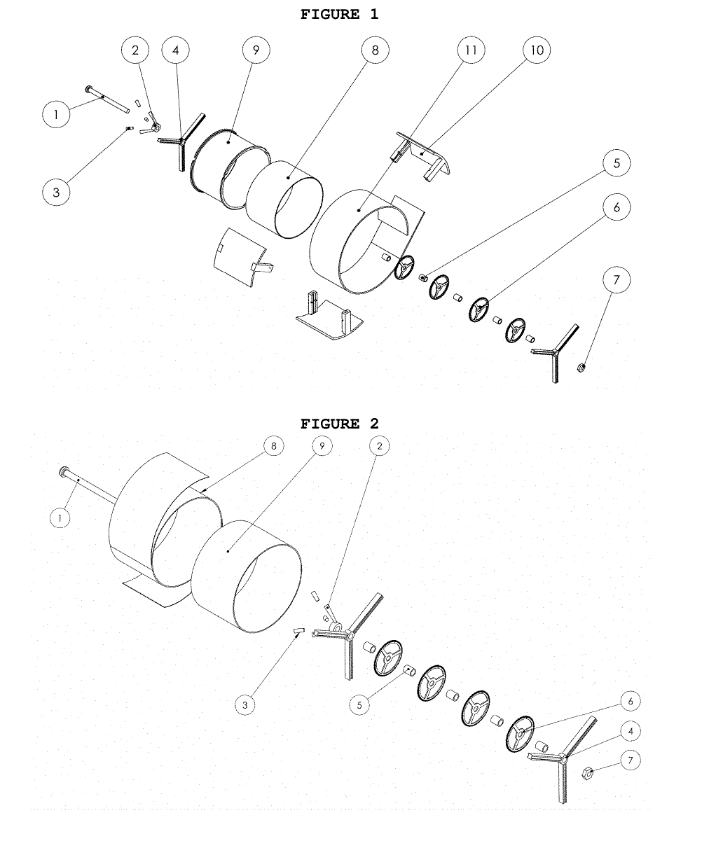

In one embodiment, the present invention discloses a plasma generation device for an internal combustion engine. In one embodiment, as shown in FIG. 1, the device comprises a beam (alternatively, “spindle”) (1), brush supporter (2), brush (3), separating unit (4), spacer (5), gear-shaped electrode (6), fastener (7), cylindrical electrode (8), dielectric barrier layer (9), supporting foot (10) and fixing spring (11).

In one embodiment, the beam (1) is to electrically connect all circular electrodes (6). In one embodiment, the beam also functions as an approach fixing the position of circular electrodes (6) so that the distance to the cylindrical electrode is substantially the same. In one embodiment, the beam is fixed in the center of the circular electrode. In one embodiment, the beam is fixed in the center of chamber of the cylindrical electrode.

In one embodiment, the brush (3) and the support (2) are made of a conductive material. In one embodiment, the conductive materials include without limitation metal, alloy, and carbon materials. In one embodiment, the brush (3) is a carbon fiber brush.

In one embodiment, the separating unit (4) is to electrically separate gear-shaped electrodes (6) from the cylindrical electrode (8). In one embodiment, the separating unit (4) is made of non-conductive material. It physically engages with the beam (1) and the cylindrical electrode (8) to maintain the electrode distance. In one embodiment, the separating unit is one or more tripods engaged with the beam (1). In one embodiment, the separating unit is a component connected to the inner wall of the air intakes. In one embodiment, the separating unit can be any other components that would achieve the same functions described herein.

In one embodiment, the spacer (5) is to separate gear-shaped electrodes. In one embodiment, the spacer (5) is made of conductive material. In one embodiment, the spacer (5) is made of non-conductive material.

In one embodiment, the circular electrode(s) (6) are an assembly of multiple thin circular electrodes with gear-shaped outer circumference. In one embodiment, the circular electrode is one cylindrical electrode with gear-shaped outer circumference.

In one embodiment, the fastener (7) is engaged to the beam (1) to fix the position of the circular electrodes. In one embodiment, the fastener (7) is a nut engaged to one end of the beam (1) with a form of a bolt.

In one embodiment, the dielectric barrier layer (9) inside the cylindrical electrode (8) is to prevent over-discharge or formation of short due to electrical break. In one embodiment, the dielectric barrier layer (9) is made of a semi-conductive material. In one embodiment, the dielectric barrier layer (9) can be a coating or a separate (sub)unit.

In one embodiment, the supporting foot (10) and fixing spring (11) are to fix the position of the cylindrical electrode within the air intake of the internal combustion engine. In one embodiment, these two components in FIG. 1 can be replaced with a fixing spring connected to the outer circumference of the cylindrical electrode (8), as shown in FIG. 2. In one embodiment, a fixing spring can be configured as one or more wings connected to or engaged with the outer circumference of the cylindrical electrode (8). In one embodiment, two fixing wings are attached to the outer circumference of the cylindrical electrode as shown in FIG. 2. In one embodiment, the fixing components shown in FIGS. 1 and 2 are used to fit air intakes with different sizes.

In one embodiment, the present invention also discloses a system comprising the plasma generation device, a voltage regulation system and a humidity control system.

In one embodiment, the voltage regulation system converts a voltage of 12V from an on-vehicle power supply to a high voltage (with a range from 0 V to −30,000 V) static electricity. In one embodiment, the voltage regulation system monitors the input voltage since the voltage is varied based on the vehicle battery charging status and engine speed, adjusts the output voltage, and/or maintain the voltage applied to electrodes of the plasma generation device within a certain range. In one embodiment, the voltage regulation system would cut down when the vehicle or engine is stopped to prevent the vehicle battery to be drained.

In one embodiment, the voltage regulation system comprising a transformer which is used to increase the voltage (or voltage difference) with an input from the electricity generated by the vehicle. In one embodiment, the voltage of the input is in a range of 7.4 to 20 v. In one embodiment, the voltage (or voltage difference) of the output is in a range of 15,000 to 30, 000 V. In one embodiment, via another system, the output voltage is fixed at a constant value or within a range so as to maximize the performance of the plasma generation device (reactor). In one embodiment, the constant voltage is 15,000 to 20,000 V. In one embodiment, the voltage of the outer cylindrical electrode is higher than that of the inner circular electrode. In one embodiment, the voltage of the inner circular electrode is higher than that of the outer cylindrical electrode.

In one embodiment, the inner circumference of the outer cylindrical electrode is a circle or an arc without gear shaped structure, while the outer circumference of the inner electrode is gear-shaped. In one embodiment, both the inner circumference of the outer cylindrical electrode and the outer circumference of the inner circular electrode are gear-shaped. In one embodiment, the gears on the outer cylindrical electrode have the same geometric structure as these on the inner circular electrode. In one embodiment, the gears on the outer cylindrical electrode have a different geometric structure as these on the inner circular electrode.

In one embodiment, the humidity control system monitors and maintains the humidity inside the air intake tube within an optimal range.

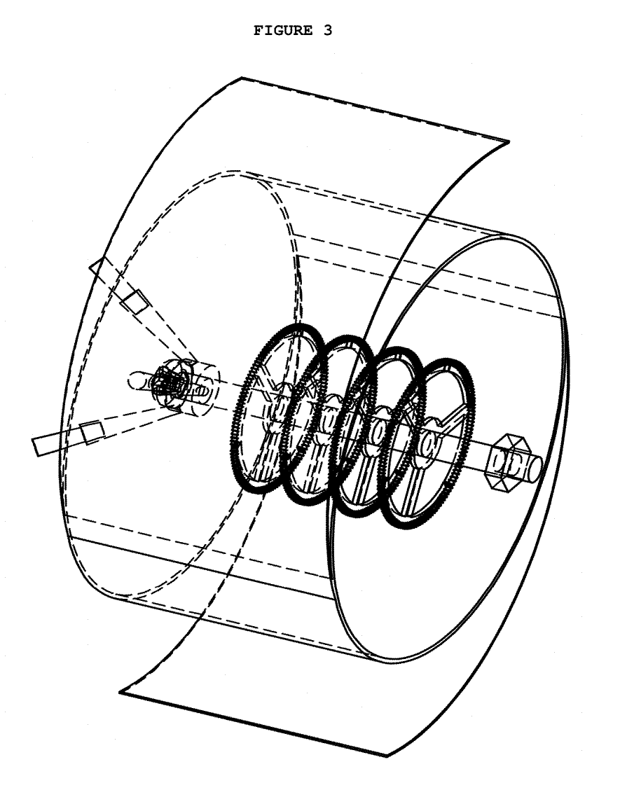

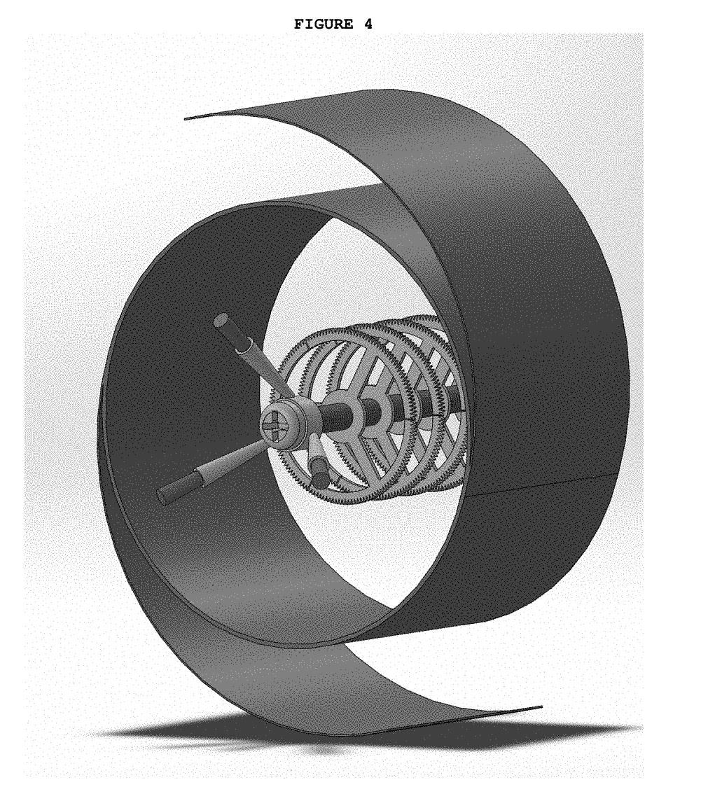

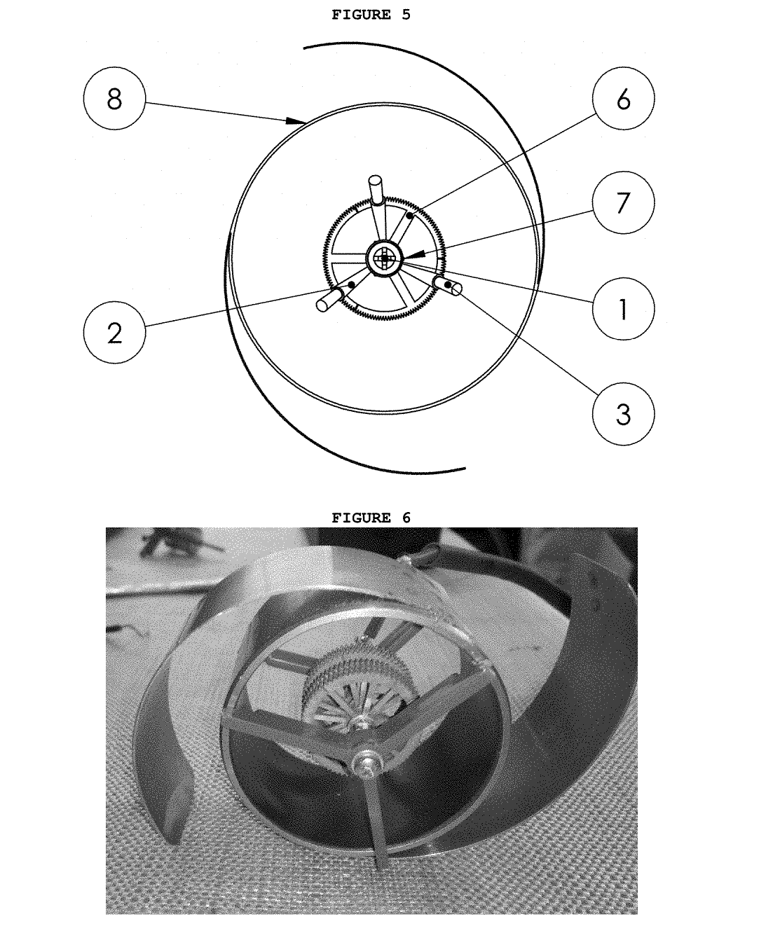

FIGS. 3-5 show a typical assembly according to one embodiment of the present invention without actually showing the separating unit (4).

In one embodiment, the plasma generation device is in communication with a high voltage supply unit. In one embodiment, the voltage supply unit comprises a transformer, which converts the vehicle's native 12V input into a high voltage. In one embodiment, the voltage between the circular electrodes and cylindrical electrode is maintained within an optimal range for plasma generation, despite the fluctuation caused by the engine speed.

In one embodiment, a humidity control system is installed to maintain an optimal humidity of the air inside the air intake tube to further improve the efficiency. In one embodiment, the humidity control system is to inject water or vapor depending on environmental factors such as temperature and atmospheric pressure.

In one embodiment, the plasma generation device is configured in a way that the distance from the top of all gears is substantially the same. While the system and methods defined herein have been particularly shown and described with references to embodiments thereof, it will be understood by those skilled in the art that various changes in form and details may be made therein without departing from the scope of the invention encompassed by the appended claims.

In one embodiment, during the process of plasma generation, a wind flow is observed.

In one embodiment, the plasma is conducted with a low power input at a low temperature manner. In one embodiment, the power input is in a range of 1-100 W. In one embodiment, the temperature is in a range of −100° C. to 100° C.

In one embodiment, the present invention discloses a device for improving performance of an internal combustion engine, comprising

1) One or more circular electrodes with outer circumference configured as gears,

2) A beam electrically connecting with the circular electrodes, and

3) A hollow cylindrical electrode surrounding the circular electrodes.

In one embodiment, the beam or the circular electrodes electrically couple to one end of a voltage supply unit, and the cylindrical electrode electrically couples to the other end of the voltage supply unit. In one embodiment, when a voltage is applied, a plasma takes place between the circular electrodes and the cylindrical electrode.

In one embodiment, the device further comprises one or more brushes extending outward from the beam.

In one embodiment, the device is placed into an air intake of the internal combustion engine.

In one embodiment, the device is immobilized within the air intake with a spring attached to the outer circumference of the cylindrical electrode.

In one embodiment, the device immobilized within the air intake is proximate to a combustion cylinder of the internal combustion cylinder.

In one embodiment, the inner circumference of the cylindrical electrode is coated with a dielectric barrier layer, or assembled with a separate part comprising the dielectric barrier layer.

In one embodiment, the beam is engaged to a separating unit which electrically separates the circular electrodes and the cylindrical electrode and maintains the distance between the circular electrodes and the cylindrical electrode substantially the same.

In one embodiment, the separating unit comprises two non-conductive tripods physically engaged to the cylindrical electrode.

In one embodiment, when multiple circular electrodes are used, one or more hollow spacers are placed between each adjacent pair.

In one embodiment, each of the circular electrodes comprises one or more holes.

In one embodiment, the outer circumference of the circular electrodes is configured with equidistant protrusions and indentations.

In one embodiment, the voltage is in a range of 15,000 to 25,000 V.

In one embodiment, the fuel consumption of the internal combustion engine is improved by 2% to 55%.

In one embodiment, the gas emission is improved by 25% to 99%.

In one embodiment, the present invention discloses a system to improve fuel consumption or gas emission for an internal combustion engine of a vehicle, comprising:

1) the plasma generation device,

2) a humidity adjuster coupling to a regulator, and

3) a voltage control unit coupling to the voltage supply unit,

In one embodiment, the humidity adjuster is to control the humidity of the air that enters into the air intake, and wherein the voltage control unit is to maintain the voltage between the circular electrodes and the cylindrical electrode within an optimal range for plasma generation.

In one embodiment, the voltage supply unit comprises a transformer which transforms a low voltage from an on-vehicle power supply unit of the subject to a high voltage.

In one embodiment, the vehicle is selected from the group consisting of automobile, boat, ship, airplane, and train.

In one embodiment, the optimal range is 15,000 to 25,000 V.

In one embodiment, the fuel consumption is improved by 2% to 55%.

In one embodiment, the gas emission is improved by 25% to 99%.

### EXAMPLES

The invention will be better understood by reference to the Experimental Details which follow, but those skilled in the art will readily appreciate that the specific experiments detailed are only illustrative, and are not meant to limit the invention as described herein, which is defined by the claims which follow thereafter.

Throughout this application, various references or publications are cited. Disclosures of these references or publications in their entireties are hereby incorporated by reference into this application in order to more fully describe the state of the art to which this invention pertains. It is to be noted that the transitional term “comprising”, which is synonymous with “including”, “containing” or “characterized by”, is inclusive or open-ended and does not exclude additional, un-recited elements or method steps.

### Example 1

A prototype according to one embodiment of the invention was obtained and a number of on-vehicle road tests were conducted. Typical measurement for the tests included, but are not limited to, force, torque, or power by a dynamometer, combustion efficiency, gas consumption, and post-combustion pollutant gas.

According to real-life road test and five-gas measurement, after the installment of the system, the post-combustion pollutant gas for a typical internal combustion engine (gasoline and diesel in this case, not limited), such as CO, hydrocarbon (HC) and NOx, reduced more than 20% and up to 90%.

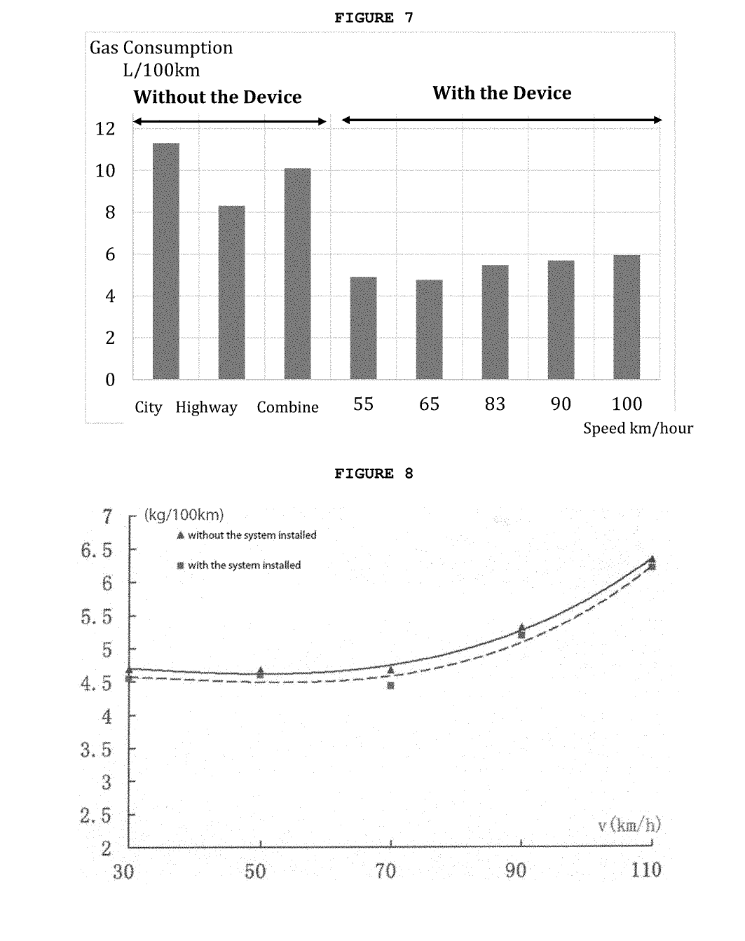

Operational results are summarized in Table 1 and FIG. 7.

According to the road test on a 2014 Toyota Camry 2.5, at an average speed of 55 km/h and with a total distance of 32.28 km, the average gas consumption was 4.91 L/100 km; at an average speed of 65 km/h and with a total distance of 9.65 km, the average gas consumption was 4.76 L/100 km; at an average speed of 83 km/h and with a total distance of 32.82 km, the average gas consumption was 5.48 L/100 km; at an average speed of 90 km/h and with a total distance of 19.74 km, the average gas consumption was 5.69 L/100 km; at an average speed of 100 km/h and with a total distance of 67.39 km, the average gas consumption was 5.96 L/100 km. In comparison to the data provided by www.fueleconomy.gov as shown in Table 1, the gasoline efficiency is significantly increased.

TABLE 1
Road Test Results on 2014 Toyota Camry 2.5 L

| | Avg. | Total | |
|---|---|---|---|
| | Speed | Distance | Avg. |
| Trial | (km/h) | (km) | Gasoline Consumption (L/100 km) |
| Baseline | n/a | n/a | City: 25 mpg (11.3 L/100 km) |
| without the | | | Highway: 34 mpg (8.3 L/100 km) |
| device | | | Combine: 28 mpg (10.1 L/100 km)* |
| 1 | 55 | 32.28 | 4.91 |
| 2 | 65 | 9.65 | 4.76 |
| 3 | 83 | 32.82 | 5.48 |
| 4 | 90 | 19.74 | 5.69 |
| 5 | 100 | 67.39 | 5.96 |

*Source: www.fueleconomy.gov/mpg/MPG.do?action=mpgData&vehicleID=34289&browser=true&details=on the 2014 Camry 2.5.

### Example 2

### Sample Installation

The device was installed inside the air-intake tube of a vehicle for the test. The results were collected after a running of 40 km.

### Measurements

The measurements for the tests included the following:
a) Fuel consumption on the D shift at a constant speed. The comparison was made between before installation and after.
b) Acceleration performance on the D shift; and
c) Emission of pollutant gas under two-speed idle conditions

### Weather and Other Conditions for Tests

At the date of the tests, the temperature was 3.6° C. The wind speed was around 1.2 m/s. The atmospheric pressure was 103.21 kPa. The tests were conducted on a high-speed looping runway and in an engine test lab.

### Test Vehicle

Test vehicle was TOYOTA ACA33 L-ANPGKV4 with an odometer reading of 146876 km and a total weight of 1825 kg. All other technical requirements under the procedures were all met.

### Fuel for the Test

Fuel for the test was Beijing-standard VI95# gasoline with a density of 0.735 g/cm³.

### Test Procedure

The tests were conducted on the vehicle with and without the device by following the following standard procedures.
GB/T 14951-2007 “Evaluation Methods for Automotive Fuel-saving Technologies”; and
GB/T 25348-2010 “Technical Rules for Use of Automotive Fuel-saving Products”.

### Main Equipment/Devices

Main equipment/devices used for the tests are listed in Table 2 below.

TABLE 2
Main equipment and device for the tests

| No. | Name | Model | ID |
|---|---|---|---|
| 1 | Road transportation vehicle | VB3iSL | PB.7.8.464-1 |
| | measurement system | | |
| 2 | Fuel flow meter | S8005C | PB.7.8.464-2 |
| 3 | Automotive emission analyzer | NHA-506 | PB.7.8.396 |
| 4 | Weather station | NK5000 | PB.7.8.448 |
| 5 | Electric vehicle weight | ZCS-15A | PB.7.91.24 |
| 6 | Engine rpm measurement tool | RPM5300 | PB.78.290 |

Note:
all test equipment is in the valid period for measurement test/calibration validation.

### Test Results

Fuel consumption under driving (D) condition was summarized in Tables 3-4. A corresponding curve FIG. 8 is to show comparison results. It is shown that when the vehicle under the D shift at a speed of 30, 50, 70, 90 and 110 km/h, the reduction percentage of fuel-consumption is 3.09%, 1.65%, 5.07%, 5.52%, and 2.08%, respectively. The normalized results in Table 4 show that a reduction percentage for City, Inter-City and Free-way can be achieved at 2.67%, 3.25% and 2.08, respectively. Such 2%-3% improvement on fuel economy is a significant progress in the auto industry since the entire industry has increased the fuel economy from 23.6 MPG in 2012 to 24.9 MPG in 2017 https://www.epa.gov/automotive-trends/highlights-automotive-trends-reports#Highlight2.

TABLE 3
Fuel Consumption

| Vehicle speed (km/h) | 30 | 50 | 70 | 90 | 110 |
|---|---|---|---|---|---|
| Fuel-consumption | 4.69/30.2 | 4.67/50.1 | 4.67/69.9 | 5.31/89.8 | 6.23/109.7 |
| (kg/100 km)/Speed | | | | | |
| (km/h) without the device | | | | | |
| Fuel consumption | 4.55/30.0 | 4.59/50.0 | 4.43/69.7 | 5.18/89.8 | 6.19/110.0 |
| (kg/100 km)/Speed | | | | | |
| (km/h) with the device | | | | | |
| Reduced fuel consumption | 0.14 | 0.08 | 0.24 | 0.13 | 0.13 |
| (kg/100 km) | | | | | |
| Reduced fuel consumption | 3.09 | 1.65 | 5.07 | 2.52 | 2.08 |
| percentage (%): | | | | | |

TABLE 4
Normalized Results

| | Normalized | |
|---|---|---|
| Running | reduction of fuel | Normalized reduction percentage |
| mode | consumption (kg/100 km) | fuel consumption (%) |
| City | 0.13 | 2.67 |
| Intercity | 0.16 | 3.25 |
| Highway | 0.13 | 2.08 |

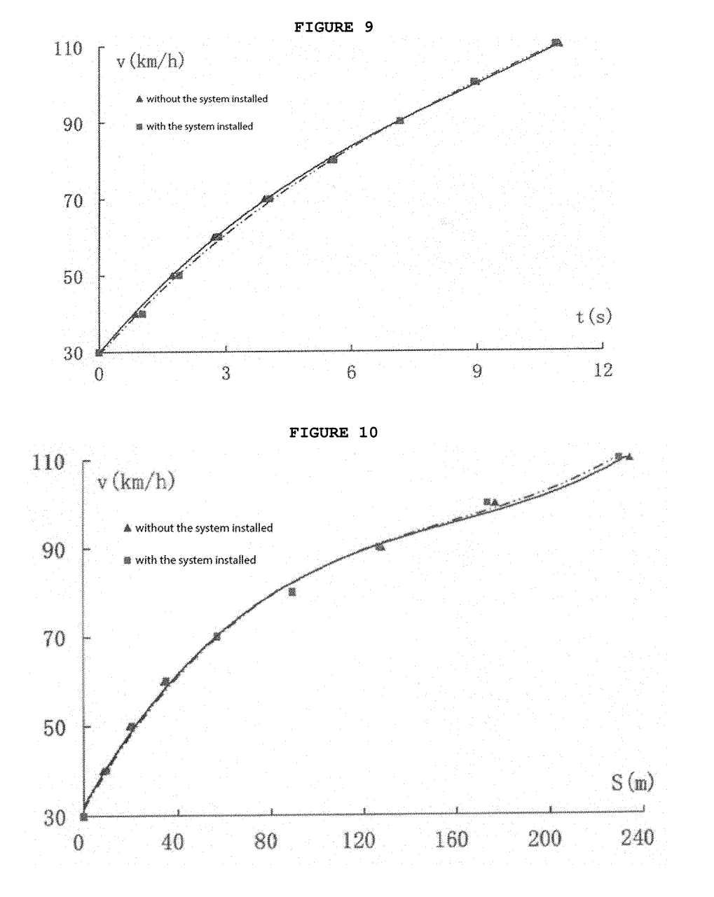

Acceleration performance under the D mode is summarized in Table 5. The corresponding curves are shown in FIGS. 9-10. It is shown that when the vehicle is accelerated from a speed 30 km/h to 110 km/h, the acceleration duration comparison index is 0.993.

TABLE 5
Acceleration Performance

| | Speed (km/h) | | | | |
|---|---|---|---|---|---|
| | 30 | 50 | 70 | 90 | 110 |
| Distance/ | 0/0 | 19.39/1.74 | 56.33/3.92 | 127.98/7.14 | 234.23/10.96 |
| Duration | | | | | |
| without the | | | | | |
| device | | | | | |
| Distance/ | 0/0 | 20.60/1.89 | 57.02/4.05 | 126.56/7.17 | 230.00/10.88 |
| Duration | | | | | |
| with the device | | | | | |

### Example 4

The prototype in Example 1 was installed into a 2003 Honda Accord (2.4 L). The pollutant gas emission was measured before and after such installation. The results can be found in Table 6. It is concluded that the device can significantly reduce the pollutant gas emission by more than 80%.

TABLE 6
Pollutant Gas Emission on Honda Accord 2.4 L (high idle: 3500 rpm)

| | Without the | With the system | Purification rate |
|---|---|---|---|
| | system installed | installed | (%) |
| CO (%) | 0.65 | 0.1 | 84.6 |
| HC (ppm) | 120 | 14 | 88.3 |
| NOₓ (ppm) | 980 | 10 | 99.0 |

### Example 5

The prototype in Example 1 was installed into a 2008 Toyota Camry 2.5 L. The pollutant gas emission was measured before and after such installation. The results can be found in Tables 7 and 8.

TABLE 7
Pollutant Gas Emission on Toyota Camry 2.5 L (Idle 2500 rpm)

| | Without the | With the system | Purification rate |
|---|---|---|---|
| | system installed | installed | (%) |
| CO (%) | 0.03 | 0.03 | 0 |
| HC (ppm) | 12 | 6 | 50.0 |
| NOₓ (ppm) | 9 | 2 | 77.8 |

TABLE 8
Pollutant Gas Emission on Toyota Camry 2.5 L (High Idle)

| | Without the | With the system | Purification rate |
|---|---|---|---|
| | system installed | installed | (%) |
| CO (%) | 0.04 | 0.04 | 0 |
| HC (ppm) | 9 | 9 | 0 |
| NOₓ (ppm) | 4 | 3 | 25.0 |

It can be found that the efficiency of reducing pollutant gas emission depends on the status of the engine. When the engine is on idle, the device can reduce the emission of HC and NOx by 50.0% and 77.8% respectively. When the engine is on high idle, it can reduce the NOx emission by 25%.

### Example 6

The prototype in Example 1 was installed into a Toyota RAV4 2.0T. The fuel consumption was measured before and after such installation. The results are summarized in Tables 9 and 10. Accordingly, the installation of the system can reduce the average fuel consumption by 25.7% and 25.3% for a RAV4 at an average speed of 70 km/hour and 90 km/hour, respectively.

TABLE 9
Fuel consumption of vehicle at an average speed of 70 km/hour

| | | Average | | Fuel | Average Fuel | Average Fuel |
|---|---|---|---|---|---|---|
| | | Speed | Distance | Consumption | Consumption | Consumption |
| | Trial | (km/h) | (km) | (L/100 km) | (L/100 km) | Reduction (%) |
| Without | 1 | 70 | 10.44 | 5.38 | 5.49 | 25.7 |
| system | 2 | 70 | 10.53 | 5.45 | | |
| installed | 3 | 70 | 10.41 | 5.57 | | |
| | 4 | 70 | 10.32 | 5.55 | | |
| With | 1 | 71 | 10.30 | 3.98 | 4.08 | |
| system | 2 | 71 | 10.31 | 4.26 | | |
| installed | 3 | 70 | 10.31 | 4.27 | | |
| | 4 | 71 | 10.34 | 3.79 | | |

*: Average Fuel Consumption (AFC) Reduction (%) = (AFC without installation − AFC with installation)/AFC without installation × 100%.

TABLE 10
Fuel consumption of vehicle at an average speed of 90 km/hour

| | | Average | Trial | Fuel | Average Fuel | Average Fuel |
|---|---|---|---|---|---|---|
| | | Speed | Distance | Consumption | Consumption | Consumption |
| | Trial | (km/h) | (km) | (L/100 km) | (L/100 km) | Reduction (%) |
| Without | 1 | 90 | 10.51 | 6.12 | 6.12 | 25.3 |
| system | 2 | 90 | 10.59 | 6.37 | | |
| installed | 3 | 90 | 10.46 | 5.88 | | |
| | 4 | 90 | 10.43 | 6.11 | | |
| With | 1 | 91 | 10.39 | 4.94 | 4.57 | |
| system | 2 | 91 | 10.34 | 4.50 | | |
| installed | 3 | 91 | 10.34 | 4.48 | | |
| | 4 | 90 | 10.37 | 4.35 | | |

What is claimed is:

1. A device for improving performance of an internal combustion engine, comprising
1) One or more circular electrodes with outer circumference configured as gears,
2) A beam electrically connecting with said one or more circular electrodes, and
3) A hollow cylindrical electrode surrounding said circular electrodes,
wherein:
said beam or said circular electrodes electrically couple to one end of a voltage supply unit, and
said cylindrical electrode electrically couples to the other end of said voltage supply unit; and
when a voltage is applied, a plasma takes place between said circular electrodes and said cylindrical electrode.

2. The device of claim 1, further comprising one or more brushes extending outward from said beam.

3. The device of claim 1, wherein said device is placed into an air intake of said internal combustion engine.

4. The device of claim 3, wherein said device is immobilized within said air intake with a spring attached to the outer circumference of said cylindrical electrode.

5. The device of claim 4, wherein said device immobilized within said air intake is proximate to a combustion cylinder of said internal combustion cylinder.

6. The device of claim 1, wherein the inner circumference of said cylindrical electrode is coated with a dielectric barrier layer, or assembled with a separate part comprising said dielectric barrier layer.

7. The device of claim 1, wherein said beam is engaged to a separating unit which electrically separates said circular electrodes and said cylindrical electrode and maintains the distance between said circular electrodes and said cylindrical electrode substantially the same.

8. The device of claim 7, wherein said separating unit comprises two non-conductive tripods physically engaged to said cylindrical electrode and said beam.

9. The device of claim 1, wherein, when multiple circular electrodes are used, one or more hollow spacers are placed between each adjacent pair.

10. The device of claim 1, wherein each of said circular electrodes comprises one or more holes.

11. The device of claim 1, wherein the outer circumference of said circular electrodes is configured with equidistant protrusions and indentations.

12. The device of claim 1, wherein said voltage is in a range of 15,000 to 25,000 V.

13. The device of claim 1, wherein the fuel consumption of said internal combustion engine is improved by 2% to 55%.

14. The device of claim 1, wherein the gas emission is improved by 25% to 99%.

15. A system to improve fuel consumption or gas emission for an internal combustion engine of a vehicle, comprising:
1) the device of claim 1,
2) a humidity adjuster coupling to a regulator, and
3) a voltage control unit coupling to said voltage supply unit,
wherein said humidity adjuster is to control the humidity of the air that enters into an air intake of the internal combustion engine, and wherein said voltage control unit is to maintain the voltage between said circular electrodes and said cylindrical electrode within an optimal range for plasma generation.

16. The system of claim 15, wherein said voltage supply unit comprises a transformer which transforms a low voltage from an on-vehicle power supply unit of said subject to a high voltage.

17. The system of claim 15, wherein said vehicle is selected from the group consisting of automobile, boat, ship, airplane, and train.

18. The system of claim 15, wherein the optimal range is 15,000 to 25,000 V.

19. The system of claim 15, wherein the fuel consumption is improved by 2% to 55%.

20. The system of claim 15, wherein the gas emission is improved by 25% to 99%.
